(19) United States
(12) Patent Application Publication
(10) Pub. No.: US 2017/0259893 A1
(43) Pub. Date: Sep. 14, 2017

(54) AUTONOMOUS UNMANNED AERIAL SYSTEM FOR MAN OVERBOARD RECOVERY

(71) Applicant: Jonathan R. Isaacson, Orlando, FL (US)

(72) Inventor: Jonathan R. Isaacson, Orlando, FL (US)

(21) Appl. No.: 15/453,501

(22) Filed: Mar. 8, 2017

Related U.S. Application Data
(60) Provisional application No. 62/306,207, filed on Mar. 10, 2016.

(51) Int. Cl. B63C 9/00; G05D 1/00; B64F 1/00; B64C 39/02; B64F 1/02

(52) U.S. Cl. CPC B63C 9/0005; B64C 39/024; B64F 1/02; B64F 1/007; G05D 1/0088; B64C 2201/12

(57) ABSTRACT

A man overboard recovery system for use on a vessel includes one or more unmanned aerial systems configured to autonomously locate and engage a man overboard using onboard sensing equipment. Unmanned aerial system launch, recovery, health and status monitoring, and integration with existing systems is facilitated by a ground station(s) located on the vessel, in the cloud, at a remote monitoring center, or any combination of these. The unmanned aerial system(s) locates a man overboard using onboard sensing equipment including cameras or sensors for heat, infrared, ultraviolet, visible spectrum, radio frequency, or other measurable stimuli that could be used to detect and track the presence of a human body. The unmanned aerial system(s) may be configured to relay data including audio, video, location, health and status information to or from the ground station(s) and to release a payload of safety or survival apparatus in close proximity to the man overboard.

This non-provisional patent application is based on provisional application No. 62/306,207 filed Mar. 10, 2016.

### BACKGROUND OF THE INVENTION

Field of the Invention

This invention is directed to a man overboard recovery system for use on ships, such as passenger cruise ships, and more particularly to a man overboard recovery system that uses one or more unmanned aerial systems to autonomously locate and engage a person who has gone overboard using onboard sensing equipment that is activated by an existing man overboard detection system.

Discussion of the Related Art

Over 200 passengers have fallen overboard from commercial pleasure cruise vessels since the beginning of the industry. Over 70 of those incidents have occurred over the last 10 years, indicating a recent increasing trend in the frequency of these events. Of over 70 recent incidents, only 17 have been recovered, with duration from fall to recovery reaching 18 hours in one incident.

The Cruise Vessel Safety and Security Act (CVSSA) of 2010 applies to ships with capacity for sleeping more than 250 passengers that pick up or drop off passengers in the United States, and mandates vessels to install technology that detects man overboard (MOB) incidents. This mandate, however, requires only basic detection systems. Most MOB systems are comprised of CCTV camera coverage around the perimeter of the vessel and/or virtual tripwire analytics to detect falling objects. There are no regulations for accuracy, maximum duration from detection to enacting recovery procedures, or false alarm handling. The majorities of vessels takes this minimalist approach to satisfying the CVSSA mandate, and are therefore subject to substantial false alarms and the need to manually confirm incidents using CCTV, visual observation, or even counting passengers. These requirements increase the time elapsed between detection and recovery during an actual MOB incident.

If a cruise vessel travels at an average speed of 21 knots or approximately 35 feet per second and the time between detection and incident confirmation were only 10 minutes, the vessel would be almost 4 miles away from the MOB before initiating a stop procedure. This conservative estimate does not take into account wind and current affecting the drift of the MOB. In effect, recovery during an actual MOB incident is often difficult and unsuccessful.

### SUMMARY OF THE INVENTION

The present invention is directed to verify a MOB incident detected by an existing MOB detection system, locate the MOB, and provide options for engagement with the MOB (e.g. full-motion video, still photographs, two-way audio communication, etc.) throughout all stages of the recovery operation.

The invention is comprised of at least five elements: 1) an existing MOB detection system, 2) one or more unmanned aerial systems (UAS), 3) one or more ground stations that interface between the existing MOB detection system(s), UAS, and vessel navigation and monitoring systems, 4) a ground station interface to facilitate human interaction with ground stations during a recovery operation, and 5) a watch officer or other human with the appropriate authority to make key decisions during a recovery operation. A 6th element may refer to a remote monitoring center.

The invention includes at least one ground station that receives input from an existing MOB detection system and vessel navigation systems. This is used to initiate the launch of unmanned aerial system(s) (UAS) that will autonomously locate and engage a MOB. The UAS will communicate with ground station(s) to provide status updates, location data, audio, video, telemetry control, and other data.

A UAS may operate autonomously, using onboard logic and/or ground station logic, manually, based on input from a watch officer or other human with appropriate authority, or from a combination of onboard logic, ground station logic, and manual input.

This MOB recovery system may include logic onboard a UAS to initiate a pre-configured search procedure if the MOB cannot be tracked immediately after launch. The system may include logic in the ground station(s) and/or UAS to coordinate the rotation of UAs to ensure operational continuity and continuous MOB tracking in the likely event of battery depletion, signal loss, or other mission-impacting event.

A watch officer on the vessel may interface with a ground station using a ground station interface in the form of a web-based, embedded, or thick-client computer application, mobile device application, or other combination of hardware, software, or both to facilitate human interface with the system from onboard the vessel, a remote monitoring center, or both. The same ground station interface will provide the watch officer or other human with appropriate authority with information and updates, as well as allow the watch officer to manually intervene in the operation of the UAS. Further, a remote monitoring center (RMC) may assist and advise the watch officer or other human with appropriate authority onboard the vessel in MOB recovery operations. Assistance from the RMC may include monitoring of live video, sensor data, direct input to the UAS, or any other function required by a MOB recovery operation.

### BRIEF DESCRIPTION OF THE DRAWINGS

For a fuller understanding of the nature of the present invention, reference should be made to the following detailed description taken in conjunction with the accompanying drawings in which:

FIG. 1 is a diagram showing the functions that occur from detection to operation completion in one embodiment of the system.

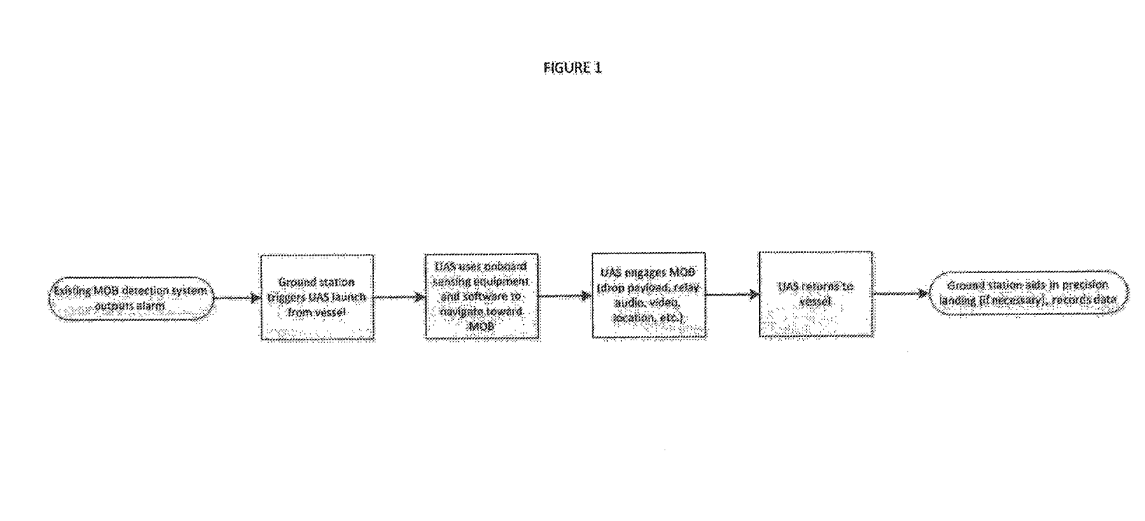

FIG. 2 is a diagram showing the operational functions and required interactions of a human watch officer in one embodiment of the system.

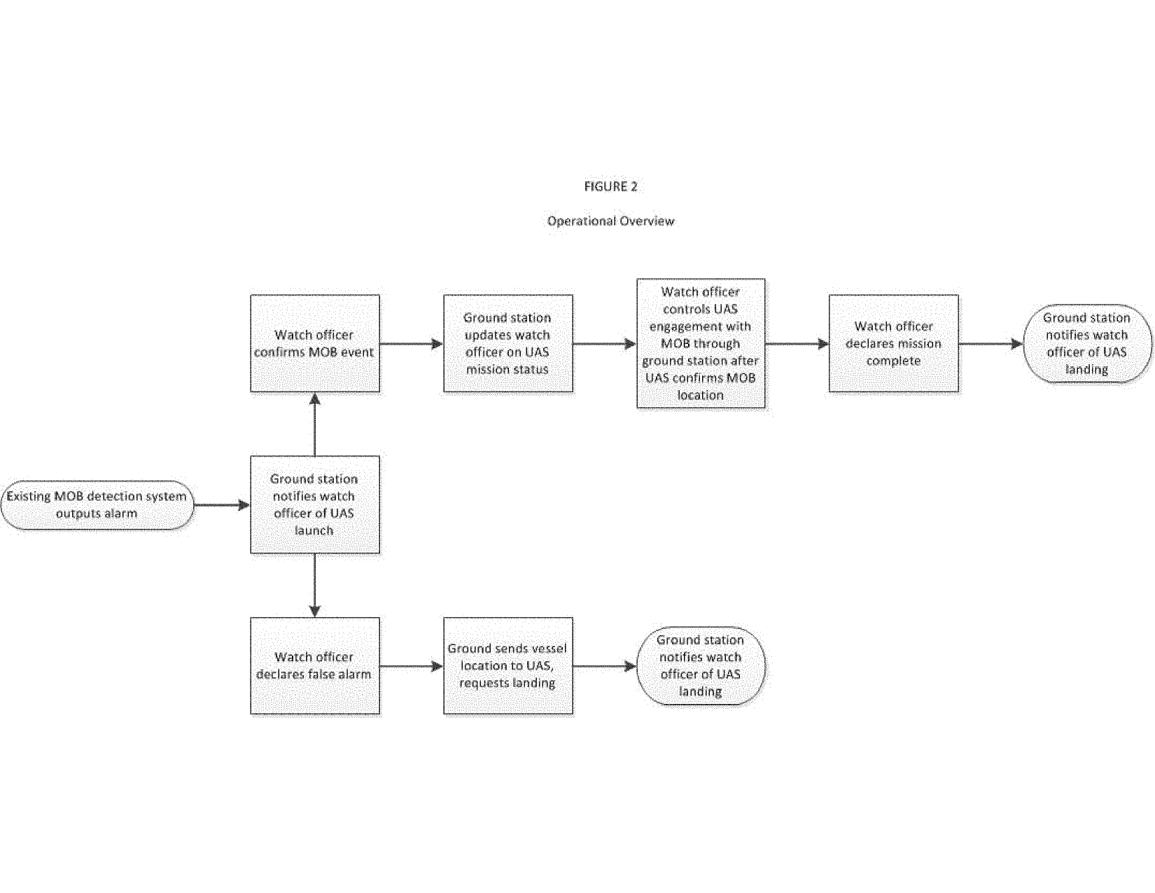

FIG. 3 is a diagram showing the functions that occur from detection to mission completion in one embodiment of the system, where the rotation of UAS is required to maintain operational continuity.

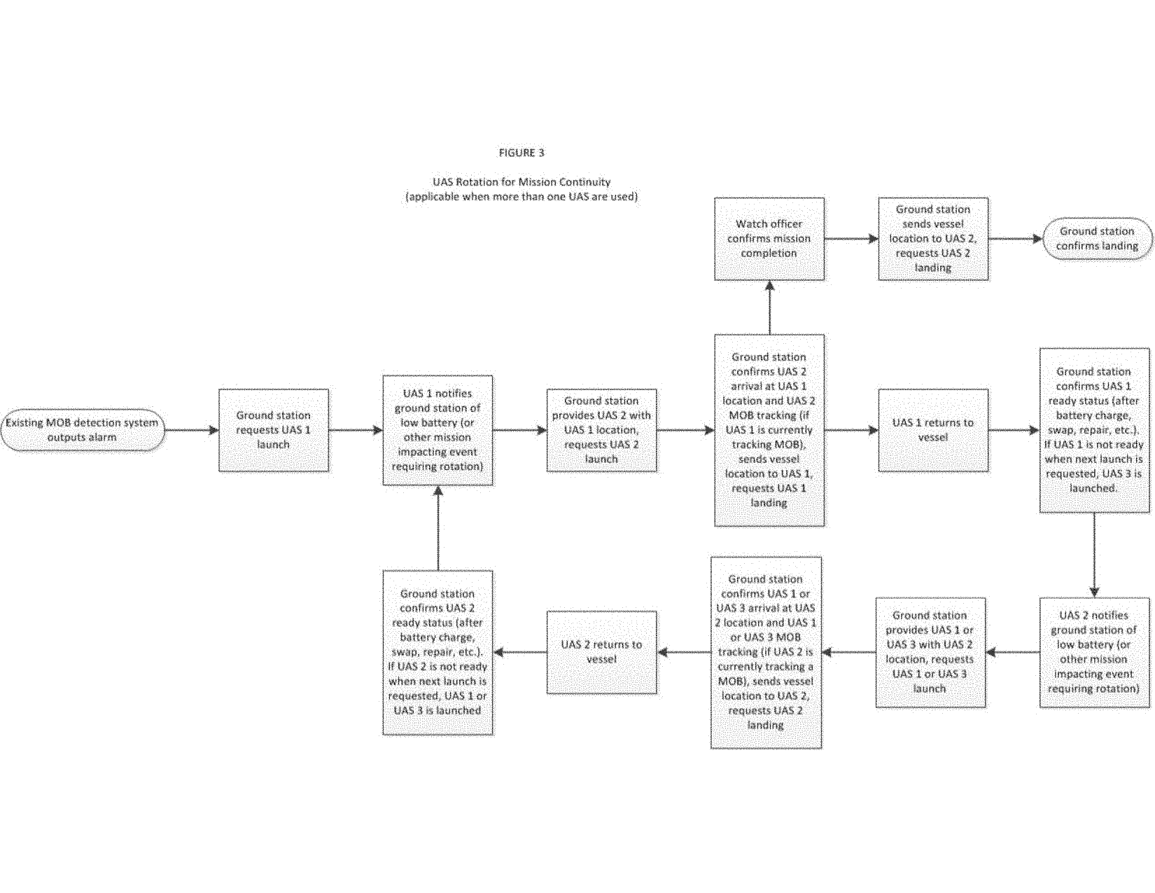

FIG. 4 is a diagram showing the functions that occur from detection to mission completion in one embodiment of the system, where the UAS is unable to track the MOB immediately upon launch.

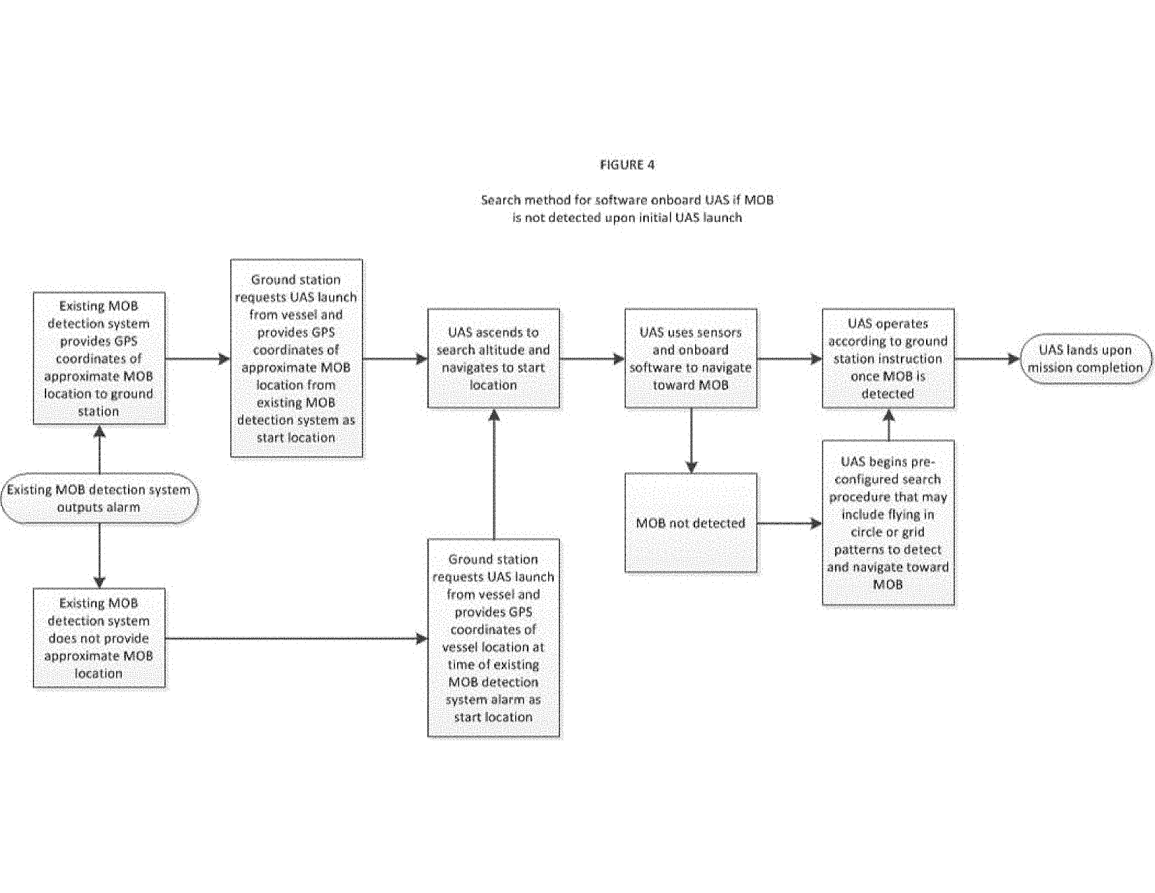

FIG. 5 is a diagram showing components of the system and their logical locations relative to the vessel and MOB in one embodiment of the system.

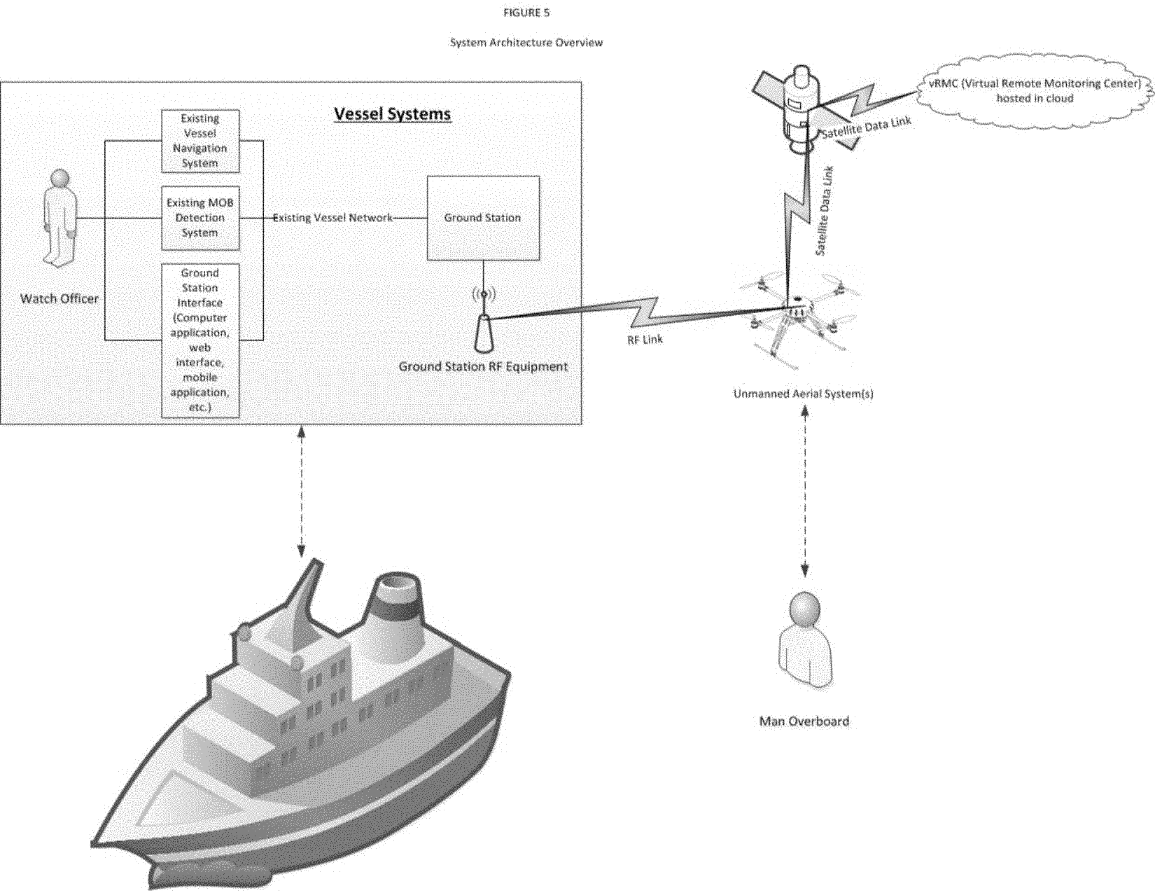

FIG. 6 is a diagram showing the logical elements onboard a UAS in one embodiment of the system.

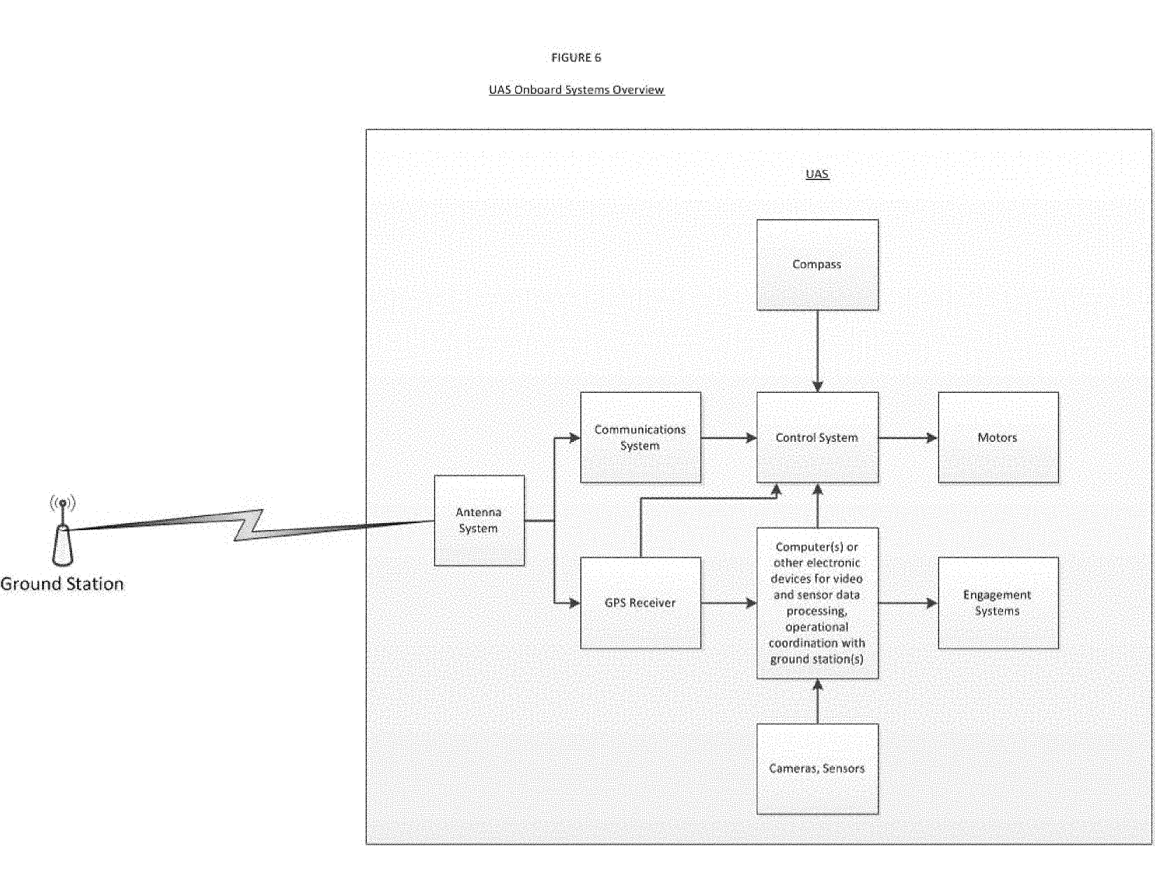

FIG. 7 is a diagram showing a logical overview of the functionality of the ground system interface with reference to ground stations.

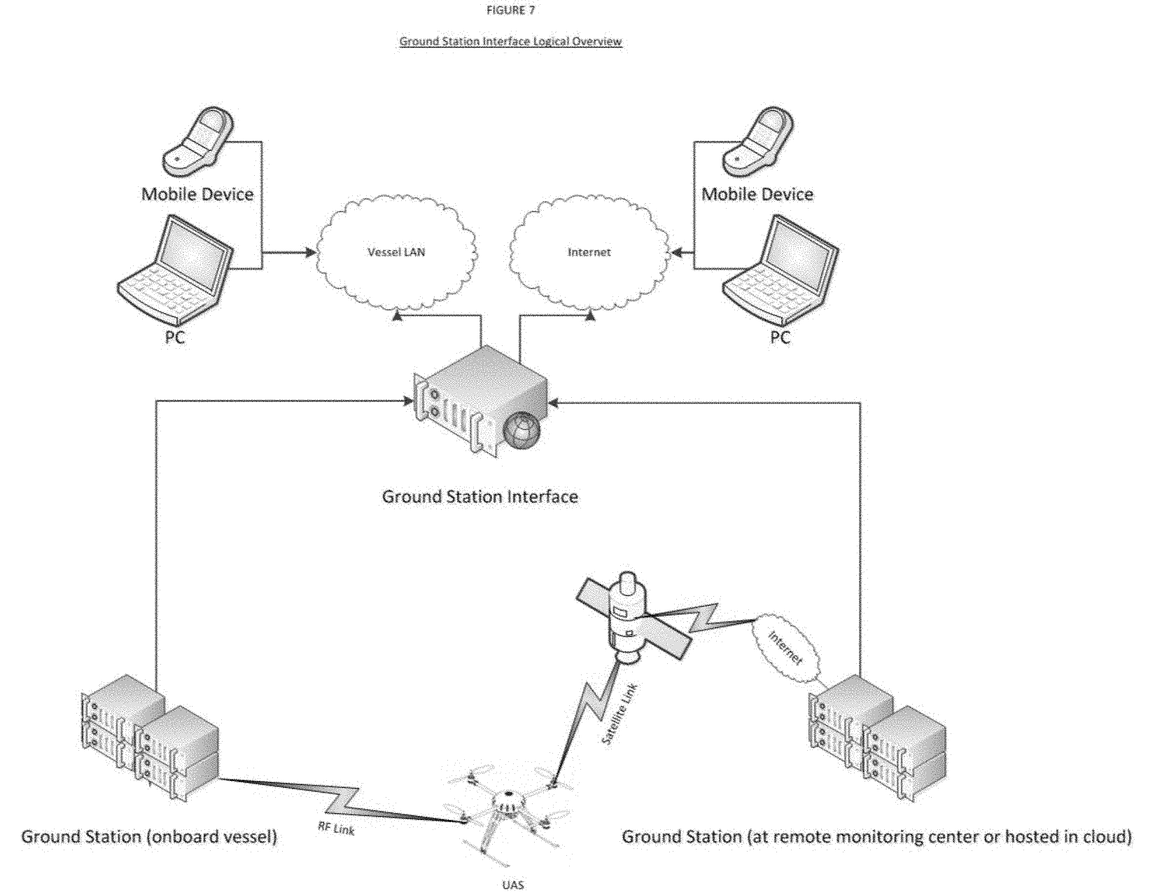

### DETAILED DESCRIPTION OF THE PREFERRED EMBODIMENTS

A man overboard (MOB) recovery system is described including one or more unmanned aerial systems (UAS) configured to autonomously locate and engage a man overboard using onboard sensing equipment once activated by an existing man overboard detection system. Unmanned aerial system launch, recovery, health and status monitoring, and integration with existing systems is facilitated by a ground station(s) located on a vessel, in the cloud, at a remote monitoring center, or any combination of these. The ground station may process or relay information provided by an existing man overboard detection system (such as approximate fall location, estimated MOB location, etc.) or vessel systems (vessel location, speed, heading, water temperature, wind speed, current data, etc.) to the UAS. The unmanned aerial system(s) locate a man overboard using onboard sensing equipment that may include cameras or sensors for heat, infrared, ultraviolet, visible spectrum, radio frequency, or other measurable stimuli that could be used to detect and track the presence of a human body. The unmanned aerial system(s) will use onboard software to allow for navigation toward sensed stimuli without aid from a human pilot or a ground station. The unmanned aerial system(s) may be configured to relay data that may include audio, video, location, health and status information to or from the ground station(s). The unmanned aerial system(s) may also be configured to release a payload of safety or survival apparatus in close proximity to the man overboard.

One embodiment of the system (which may be employed on cruise ships or other large seagoing vessels) includes at least one ground station, at least one UAS, a ground station interface, and a watch officer or other human with appropriate authority. The ground station consists of one or more computers or electronic devices with logic configured to manage the deployment, operation, and maintenance of UAS for man overboard recovery. This ground station may be located on a vessel or on a computer server in the cloud or other remote location. Communications between the vessel and UAS, vessel systems and UAS, vessel and ground station(s), vessel systems and ground station(s), ground station(s), existing man overboard detection systems and ground station(s), existing man overboard detection systems and UAS, and ground station(s) and UAS may be facilitated by new or existing data or telecommunication networks and satellite or radio frequency communication systems (Transmission methods may include line-of-sight VHF, UHF, SHF, Cellular, WiFi, WiMax, or a combination of these and other methods). Communications may be encrypted, may be analog or digital, and may use packet transmission methods to transport voice, video, telemetry, or other relevant information using electronic signals between wireless devices. These signals may be modulated or multiplexed across one or more frequencies to make efficient use of the electromagnetic spectrum.

When an existing man overboard detection system detects a man overboard incident, a ground station will receive an electronic signal. The ground station is configured to interpret the signal as a trigger to initiate a man overboard recovery operation. Upon initiation a man overboard recovery operation, a ground station will execute pre-configured tasks including: triggering an electronic notification on the vessel's bridge, triggering an electronic notification to the captain or designated watch officer through a ground station interface, triggering an electronic notification to another ground station, and triggering an electronic notification to a UAS.

Electronic notifications sent to the vessel's bridge, captain, watch officer, or other human with appropriate authority will alert them that a recovery operation has begun. At this stage, a human with the appropriate authority must provide electronic confirmation to a ground station through a ground station interface that the recovery operation was initiated due to an actual man overboard incident or due to a false alarm within a predetermined amount of time. If an actual incident is not confirmed in the predetermined amount of time, logic in the ground station(s) and UAS will be configured to abort the recovery operation if a UAS has not yet independently started tracking a man overboard. An electronic notification sent to another ground station may be used to alert ground-based personnel on-call or at a remote monitoring center that a recovery operation was initiated. Ground-based personnel on-call or at a remote monitoring center may be provided electronic access to ground station(s), UAS, and vessel systems to aid shipboard personnel in incident confirmation and management of the recovery operation. The electronic notification to a UAS will immediately launch the UAS. This notification may include the vessel's global positioning system (GPS) coordinates recorded when a ground station received an electronic signal from an existing man overboard detection system, a approximate incident location or estimated search location. This input may be automated through an existing MOB detection system or by manual input.

A UAS will launch immediately upon receiving electronic notification from a ground station, even if an actual man overboard incident has not yet been confirmed. The UAS will navigate to the location provided by an existing man overboard system, a set of GPS coordinates generated by ground station or vessel systems based on MOB trigger, or by a manually inputted set of GPS coordinates. Once the UAS arrives at the location, a computer or other electronic device onboard the UAS will begin processing sensor data with logic configured to analyze the data to detect and track a man overboard. Sensors may include cameras or other sensors designed to measure heat, infrared, ultraviolet, visible spectrum, radio frequency, or other stimuli that could be used to detect and track the presence of a human body.

If the computer or other electronic device onboard the UAS detects a man overboard, the computer or other electronic device will begin providing the UAS' control systems (autopilot, navigation system, etc.) with guidance data. Once the UAS has arrived the MOB search location, a computer or other electronic device onboard the UAS will direct the UAS' control systems to descend to a lower altitude. This guidance will take into account conditions hazardous to the UAS and proximity to the man overboard. The UAS may use onboard sensors to capture still photographs, videos, or audio, and to use onboard equipment to release survival or safety equipment that will land in close proximity to the man overboard. In addition, if the UAS detects presence of a human MOB in the water, the UAS' communication systems will transmit an electronic notification to the ground station(s) to inform them that a possible man overboard has been located. The UAS will then begin to engage the man overboard. This engagement may be controlled manually by a human through a ground station interface, or automatically, through computers or other electronic devices onboard the UAS. Examples of engagement may include capture and transmission of still photographs or videos to ground station(s), initiation of two-way audio communication between the man overboard and a human through ground station(s), payload release for the provision of rescue, safety, or survival equipment to or nearby the man overboard, recording and transmission of location data to ground station(s) and/or rescue providers (search and rescue, Coast Guard, etc.), and/or continuous tracking of the man overboard until the recovery operation has been completed.

If a man overboard is not detected by the computer or other electronic device onboard the UAS, the UAS' communication systems will transmit an electronic notification to ground station(s) to inform them that no man overboard has been detected. At this time, the UAS will begin autonomously navigating a pre-configured search pattern until a man overboard is detected or the recovery operation is completed or aborted.

If a UAS engaged in any stage of the recovery operation approaches a level of endurance (low fuel, battery power, etc.) which may jeopardize its ability to safely return to the vessel, onboard communication systems will transmit an electronic notification to ground station(s) that a relief UAS for operational continuity. The ground station(s) will contain logic configured to initiate the launch of another UAS onboard the vessel that has full endurance capability (full fuel, battery power, etc.). The ground station(s) will provide the launching UAS with data necessary for the UAS to vector toward the on-station UAS with low endurance and assume its responsibilities in its current step of the recovery operation. Once the UAS with full endurance capability successfully completes a handover with the on-station UAS, the UAS with reduced endurance will return to the vessel. Once the UAS with reduced endurance returns to the vessel, it will be manually or automatically restored to full endurance capability. Additional UAS may be standing by onboard the vessel in the event that the UAS with reduced endurance can't be restored to full endurance capability by the time its relief UAS runs out of endurance. This process may continue until the recovery operation is completed or aborted.

A human with appropriate authority must confirm completion of a recovery operation or abort a recovery operation by providing electronic notification through an interface to a ground station. Once an operation is confirmed completed or aborted, a ground station will transmit an electronic notification to any UAS engaged in the recovery operation requesting that the UAS return to the vessel. Once a UAS is in close proximity to the vessel, a ground station may begin to increase frequency of location updates to the UAS in order to assist in the landing process. Additionally, UAS may use computer or electronic systems onboard the UAS or vessel to aid in precision landing. These systems may include radar, LIDAR, IR sensors and/or transmitters, visible spectrum video cameras, and/or RFID sensors and/or transmitters. If a precision landing is not possible, UAS may be landed by a human using manual control through a ground station or by using a safety device such as a landing pad, net, chamber, or other apparatus designed to stop UAS movement without damaging the UAS or imposing safety risk to vessel crew, passengers, or other persons.

### Definitions and Context Clarifications

“Vessel” in this context refers to a ship or a large boat. Although exemplary diagrams, references, or embodiments may have used the word vessel in reference to a passenger cruise ship, the claims herein are intended to be applicable to any ship or large boat.

“Cloud” or “The Cloud” in this context refers to a network of remote servers hosted on the Internet and used to store, manage, and process data in place of local servers or personal computers. Those skilled in the art will recognize that “cloud” is a general term for delivery of hosted services over the internet, and in this context may refer to a service through which a ground station and required resources are hosted by a third party and made accessible to the customer anywhere in the world with internet connectivity.

“Telemetry” in this context refers to one-way or two-way analog signals or digital data streams that transmit status, sensor, and flight data down to a ground station, and send administrative or flight commands up to a UAS autopilot or navigation system.

References to “one embodiment” or “an embodiment” do not necessarily refer to the same embodiment, although they may. Unless the context clearly requires otherwise, throughout the description and the claims, the worlds “comprise”, “comprising”, “contains”, “includes”, and the like are to be construed in an inclusive sense as opposed to an exclusive or exhaustive sense; that is to say, in the sense of “including, but not limited to.” Words using the singular or plural number also include the plural or singular number respectively, unless expressly limited to single one or multiple ones. Additionally, the words “above”, “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other.

“Logic” refers to machine memory circuits, machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), software, scripts, and firmware are examples of logic.

Those skilled in the art will appreciate that logic may be distributed throughout one or more devices, and/or may be comprised of combinations of memory, media, processing circuits and controllers, other circuits, and so on. Therefore, in the interest of clarity and correctness, logic may not always be distinctly illustrated in drawings of devices and systems, although it is inherently present herein.

The techniques and procedures described herein may be implemented via logic distributed in one or more computing or electronic devices. The particular distribution and choice of logic is a design decision that will vary according to implementation.

Those skilled in the art will appreciate that there are various logic implementations by which processes and/or systems described herein can be effected (e.g., hardware, software, scripts, and/or firmware), and that the preferred vehicle will vary with the context in which the processes are deployed. “Software” or “scripts” refer to logic that may be readily readapted to different purposes (e.g. read/write volatile or nonvolatile memory or media). “Firmware” refers to logic embodied as read-only memories and/or media. Hardware refers to logic embodied as analog and/or digital circuits. If an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, scripts, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, scripts, and/or firmware.

The detailed description has set forth an embodiment of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, scripts, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software, scripts, and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

In a general sense, those skilled in the art will recognize that the various aspects described herein which can be implemented, individually and/or collectively, by a wide range of hardware, software, or any combination thereof can be viewed as being composed of various types of “circuitry”. Consequently, as used herein “circuitry” includes, but is not limited to, electrical circuitry having at least one application specific integrated circuit, circuitry forming a general purpose computing device configured by a computer program (e.g., a general purpose computer configured by a computer program which at least partially carries out processes and/or devices described herein, or a microprocessor configured by a computer program which at least partially carries out processes and/or devices herein), circuitry forming a memory device (e.g., forms of random access memory), and/or circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “connected” or “coupled”, to each other to achieve the desired functionality.

What is claimed is:

1. A system for use on a vessel comprising:
one or more unmanned aerial systems configured to autonomously locate and engage a man overboard using sensing equipment onboard the vessel once activated by an existing man overboard detection system; and
one or more ground stations configured to facilitate, coordinate, and manage unmanned aerial system launch, recovery, health and status monitoring, and integration with existing systems onboard the vessel or at remote locations.

2. The system of claim 1, further comprising:
logic for alerting vessel crew members of the status of a recovery operation, launch of the one or more unmanned aerial systems, and for allowing the alerted vessel crew members to confirm a real incident, resulting in continuance of the recovery operation, or to manually or automatically declare a false alarm based on human input or a time-out event, resulting in abortion of the recovery operation.

3. The system of claim 1, further comprising:
logic for coordinating the rotation of the unmanned aerial system(s) to ensure operational continuity and completion.

4. The system of claim 1, further comprising:
logic for instructing the one or more unmanned aerial systems to autonomously search for a man overboard without the provision of data or direction from an existing man overboard detection system, other than an electronic trigger, notification, or alarm indicating the detection of a man overboard incident.

5. The system of claim 1, further comprising:
a distributed architecture that allows for the internetworking of the one or more unmanned aerial systems launched from the vessel, the one or more ground stations, and existing computer or electronic systems onboard the vessel or used by the vessel crew members or remote support personnel; and
logic that allows any step of a man overboard recovery operation utilizing the one or more unmanned aerial systems to be controlled or monitored autonomously by the one or more unmanned aerial systems or a combination of the ground stations and the one or more unmanned aerial systems, or manually with human interaction through interfaces to the ground stations onboard the vessel or at the one or more remote locations.

6. The system of claim 1, further comprising:
logic for instructing the one or more unmanned aerial systems to autonomously launch and land on the vessel while the vessel is moving using transmitters and sensors onboard the one or more unmanned aerial systems or onboard the vessel; and
a safety device for stopping movement of the one or more unmanned aerial systems without damaging the one or more unmanned aerial systems or imposing safety risk to the vessel crew members or passengers.

7. The system of claim 1, further comprising:
a ground station interface for providing a human interface with the ground stations.

8. The system of claim 6 wherein the safety device is a landing pad.

9. The system of claim 6 wherein the safety device is a net.

10. The system of claim 6 wherein the safety device is a chamber.

11. The system of claim 7 wherein the ground station interface is structured for providing location data to the vessel crew members onboard the vessel.

12. The system of claim 7 wherein the ground station interface is structured for providing health and status information to the vessel crew members onboard the vessel.

13. The system of claim 7 wherein the ground station interface is structured for providing sensor data to the vessel crew members onboard the vessel.

14. The system of claim 7 wherein the ground station interface is structured for providing video to the vessel crew members onboard the vessel.

15. The system of claim 7 wherein the ground station interface is structured for providing audio to the vessel crew members onboard the vessel.

16. The system of claim 7 wherein the ground station interface is structured for providing telemetry control to the vessel crew members onboard the vessel.
